(19) United States
(12) Patent Application Publication
(10) Pub. No.: US 2025/0337090 A1
(43) Pub. Date: Oct. 30, 2025

(54) PRESSURE RELIEF DEVICE AND HOUSING

(71) Applicant: ElringKlinger AG, Dettingen (DE)

(72) Inventor: Axel STREICHER, Dettingen (DE)

(73) Assignee: ElringKlinger AG, Dettingen (DE)

(21) Appl. No.: 19/262,269

(22) Filed: Jul. 8, 2025

Related U.S. Application Data
(63) Continuation of application No. PCT/EP2024/051761, filed on Jan. 25, 2024.

(30) Foreign Application Priority Data
Jan. 30, 2023 (DE) 10 2023 102 182.6

(51) Int. Cl. H01M 50/317; H01M 50/30

(52) U.S. Cl. CPC H01M 50/317; H01M 50/394

(57) ABSTRACT

A pressure relief device for opening a relief opening in a housing, in particular a battery storage housing, said pressure relief device providing a safe mode of functioning and having a simple structure, it is proposed that the pressure relief device has a main body which can be arranged in the relief opening and has a passage which connects an inlet and an outlet through which a medium can flow, a closing element which, if a defined activation pressure is exceeded, can be transferred from a closed position, in which the closing element closes the passage, to an open position in which the closing element releases the passage, and a cover which at least partly covers the closing element and/or passage and performs a setting movement with the closing element in order to release the passage.

### RELATED APPLICATION

This application is a continuation of international application No. PCT/EP2024/051761 filed on Jan. 25, 2024, and claims the benefit of German application No. 10 2023 102 182.6 filed on Jan. 30, 2023, which are incorporated herein by reference in their entirety and for all purposes.

### FIELD OF DISCLOSURE AND BACKGROUND

The present invention relates to a pressure relief device for opening a relief opening in a housing, in particular a battery storage housing, and a housing, in particular a battery storage housing, for receiving one or more battery modules.

### SUMMARY OF THE INVENTION

An object of the present invention is to provide a pressure relief device which provides a safe operating method and has a simple structural design.

This object is achieved according to the invention by a pressure relief device for opening a relief opening in a housing, in particular a battery storage housing, having a base member which can be arranged in the relief opening and which has a passage which connects an inlet and an outlet for the throughflow of a medium, a closure element which, when a defined activation pressure has been exceeded, can be moved from a closed position in which the closure element closes the passage into an open position in which the closure element releases the passage, and a cover which at least partially covers the closure element and/or the passage and in order to release the passage carries out a setting movement with the closure element.

In particular batteries which are received in a battery storage housing can overheat and degas in the event of a defect, for example, a short-circuit, or in the event of excessively high ambient temperatures. In this instance, large quantities of gas which have to be discharged from the housing can be released.

The pressure relief device can, when the defined activation pressure is exceeded, that is to say, in the event of an excess pressure in the interior of the housing, for example, enable a so-called burst pressure, a discharge of the medium, in particular a gas, from an interior of the housing.

Preferably, the closure element as a result of a gas pressure, which exceeds the defined activation pressure, inside the housing is moved as a result of a setting movement from the closed position to the open position and thereby releases the passage.

Preferably, the passage is released by the setting movement of the closure element from the closed position into the open position in such a manner that the medium flows via the inlet through the passage and out of the outlet. The medium can also flow through the pressure relief device in the opposite direction.

As a result of the cover which at least partially covers the closure element and/or the passage, a protection from external influences, for example, dust, dirt, fluids and the like, may be provided.

In a further development of the pressure relief device, the cover may be coupled to the closure element and carry out the setting movement together with a setting movement of the closure element from the closed position into the open position.

Preferably, the closure element and the cover may be actively connected to each other.

By the closure element and the cover being actively connected to each other, the closure element and the cover can be moved together into the open position when either the setting movement of the closure element or the setting movement of the cover is controlled.

An advantageous embodiment of the pressure relief device may make provision for the cover to be fitted to the closure element.

In particular, the cover may be fitted to the closure element by means of a plug connection, locking connection, weld connection, adhesive-bonding connection or the like.

Preferably, there may be provided on the cover one or more retention elements by means of which the cover may be fitted to the closure element.

The cover may be both releasably fitted to the closure element and securely fixed to the closure element.

In an alternative embodiment of the pressure relief device, there may be provision for the cover to be formed integrally with the closure element or with a component of the closure element.

Preferably, the cover and the closure element or the component of the closure element may be in the form of a common shaped member, for example, plastics material shaped member.

For example, the cover and the closure element or the cover and the component of the closure element may be in the form of an integral injection-molded component.

A particularly preferred further development of the pressure relief device may make provision for the outlet in the open position of the closure element and the cover to have a flow path free from diversions in the radial direction for the medium which flows through the outlet to an outer side.

Preferably, the medium can be diverted after flowing through the passage by the closure element in the radial direction and then discharged in the radial direction without any diversions to the outer side.

As a result of the flow path, which is free from diversions in a radial direction, of the outlet the medium may be able to be discharged with a low pressure loss to the outer side. As a result of the pressure relief device, a maximized volume flow may thereby be able to be discharged from the interior of the housing to the outer side.

Another advantageous embodiment of the pressure relief device may additionally make provision for the cover and the closure element in the open position to be arranged in a position which is raised with respect to the base member and in which the passage through a free circumferential flow cross section of the outlet to an outer side is released.

In particular, the cover and the closure element are moved as a result of the setting movement into the position raised with respect to the base member.

In the open position or the raised position, the base member and the closure element and the cover may be arranged with spacing from each other.

In particular in the open position, the free circumferential flow cross section of the outlet is formed by a spacing between the base member and the closure element and the cover.

Preferably, the outlet has a flow cross section which is formed in a radial direction completely circumferentially between the base member and the closure element and the cover.

An embodiment of the pressure relief device may make provision for the cover to have a cover portion and a circumferential portion which delimits the cover portion, wherein the circumferential portion extends in such a manner that it at least partially covers an outer circumference of the closure element.

Preferably, the cover is in the form of a shaped member, for example, a plastics material shaped member, in particular an injection-molded element.

In particular, the cover has a circular geometry in plan view. The cover may have a plate-like or pot-like shape.

Preferably, the circumferential portion surrounds the cover portion completely circumferentially and extends from the cover portion in a form which is bent with respect to the base member so that the circumferential portion covers the outer circumference of the closure element.

Preferably, there is provision for an end of the circumferential portion to extend in the direction of the base member substantially up to the height of a lower side, which faces the passage, of the closure element.

Advantageously, with the pressure relief device there may additionally be provision in the open position for the diversion-free flow path of the outlet to the outer side to be formed by a spacing which is formed in a setting movement direction between an end portion of the cover and the base member, in particular an edge region, which delimits the passage, of the base member.

Preferably, the spacing provided in the setting movement direction between the end portion of the cover and the base member, in particular the edge portion, which delimits the passage, of the base member, may be 10 mm or more, preferably 20 mm or more, in a particularly preferred manner 30 mm or more.

In one embodiment of the pressure relief device, there may additionally be provision for the closure element to have a gas passage through which in the closed position of the closure element a gas exchange is provided between an inlet-side interior and an outlet-side outer side.

As a result of the gas exchange through the gas passage, in the closed position of the closure element a pressure compensation may be enabled between the interior of the housing and an outer side.

In particular, as a result of the gas passage, a gas exchange between the interior and the outer side is enabled and a fluid exchange between the interior and the outer side is prevented.

Preferably, the gas exchange may be enabled through the gas passage both from the interior in the direction of the outer side and in the opposite flow direction.

Preferably, the gas passage may be formed by one or more apertures, channels, holes or the like.

A further development of the pressure relief device may make provision for a gas-permeable and fluid-non-permeable element, in particular a permeable membrane, to be provided in the gas passage.

In particular, the permeable membrane enables the gas exchange between the interior and the outer side and prevents penetration of fluid from the outer side into the interior of the housing.

The membrane may be formed from any suitable material which enables the gas exchange and which prevents the penetration of fluid from the outer side in the direction of the interior of the housing.

Advantageously, with the pressure relief device there may be provision for providing a setting device by means of which, when the defined activation pressure is exceeded, the setting movement of the closure element and/or the cover from the closed position into the open position can be controlled.

The setting device may have a pressure activation apparatus which is associated with the inlet and on which an inlet-side gas pressure, in particular a gas pressure in the interior of the housing, acts.

Preferably, the pressure activation apparatus may be configured to control the setting device when the defined activation pressure is exceeded and to initiate the setting movement of the closure element and/or the cover.

A preferred further development of the pressure relief device may additionally make provision for the setting device to have an energy storage element which is actively connected to the closure element and/or the cover and which, when the defined activation pressure is exceeded, controls the setting movement of the closure element and/or the cover.

In particular, the energy storage element is in the form of one or more resilient elements.

Preferably, in the closed position of the closure element and the cover the energy storage element is arranged in an activated configuration, for example, a pretensioned configuration. When the defined activation pressure has been exceeded, the activated energy storage element is initiated in order to act on the closure element and/or the cover and to control the setting movement of the closure element and the cover into the open position.

In a further development of the pressure relief device, the base member and/or the closure element and/or the cover may at least partially be formed from a composite material or a thermoplastic plastics material.

Preferably, the base member and/or the closure element and/or the cover may be formed from any thermoplastic plastics material or any composite material, for example, PBT-GF30.

The base member and/or the closure element and/or the cover may in each case be formed from the same material or be formed from different materials.

The base member may also be formed from any other suitable material, for example, a metal, in particular light metal.

A configuration of the pressure relief device may additionally make provision for the base member to be able to be fixed in the relief opening of the housing, in particular by means of a bayonet closure, a plug connection, screw connection, locking connection, clip-fit connection or the like, or for the base member to be formed integrally with the housing or a component of the housing.

Preferably, there are formed on the base member and on the housing mutually corresponding connection elements which form the bayonet closure, the plug connection, the screw connection, the locking connection, the clip-fit connection or the like.

As a result of the bayonet closure, the plug connection, the screw connection, the locking connection, the clip-fit connection or the like, the base member may be fixed to the housing.

In an alternative embodiment of the pressure relief device, the base member may be configured integrally with the housing or the component of the housing.

For example, the base member may be welded, adhesively-bonded or the like to the housing or the component of the housing or the base member may be formed with the housing or the component of the housing as an integral component, for example, as an injection-molded component.

Another object of the invention is to provide a housing, in particular a battery storage housing, for receiving one or more battery modules which enables safe operation and has a simple structure.

This object is achieved with a housing, in particular a battery storage housing, for receiving one or more battery modules, having a housing member which surrounds an interior, and at least one relief opening which is provided in the housing member and which forms a connection between the interior and an outer side, wherein in the at least one relief opening a pressure relief device according to one of the embodiments described above is provided.

The housing preferably comprises one or more pressure relief devices according to the invention which is provided in each case in a relief opening in the housing.

In particular in the event of a defect of batteries which are received in a battery storage housing, large quantities of gas which must be discharged from the housing can be released.

As a result of the provision of one or more pressure relief devices, when a defined activation pressure inside the housing is exceeded, in particular in the event of a critical excess pressure, a discharge of the gas from the interior of the housing may be enabled.

Such a battery storage housing is preferably suitable for use in motor vehicles, buses, trucks and the like.

Other preferred features and/or advantages of the invention are set out in the following description and the drawings of exemplary embodiments.

### BRIEF DESCRIPTION OF THE DRAWINGS

FIG. 1 shows a schematic sectioned view of an embodiment according to the invention of a pressure relief device in a closed configuration;

FIG. 2 shows a schematic sectioned view of the pressure relief device in FIG. 1 in an open configuration.

Identical or functionally equivalent elements are given the same reference numerals in all the Figures.

### DETAILED DESCRIPTION OF THE DRAWINGS

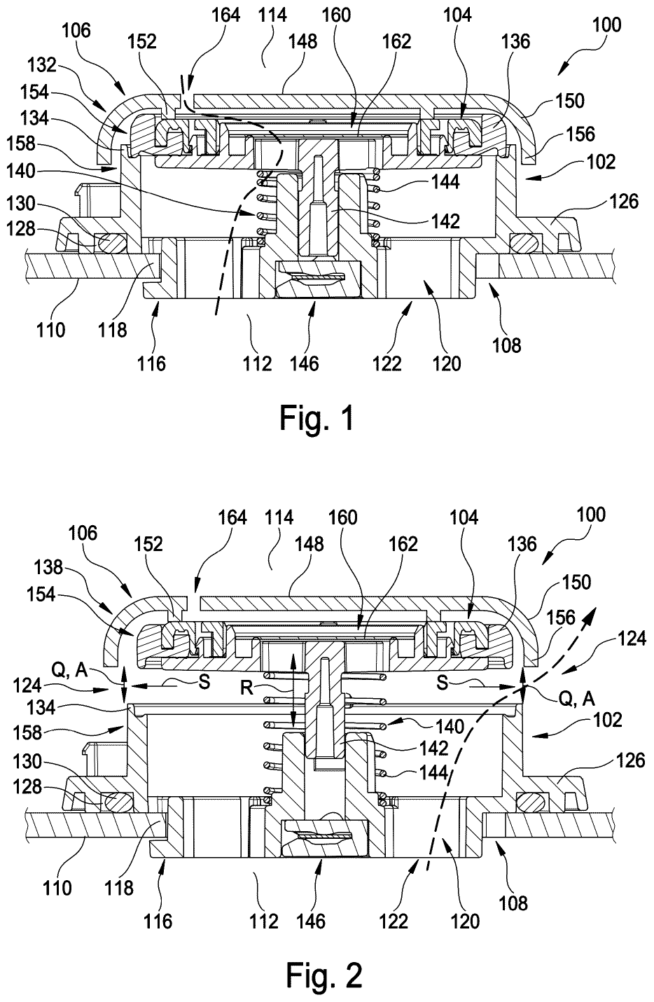

FIGS. 1 and 2 show schematic sectioned views of an embodiment according to the invention of a pressure relief device which is generally designated 100.

FIG. 1 shows the pressure relief device 100 in a closed configuration in which a throughflow of the pressure relief device 100 by a medium is prevented. FIG. 2 shows the pressure relief device 100 in an open configuration in which the throughflow of the pressure relief device 100 by the medium is enabled.

The pressure relief device 100 may have a substantially round geometry. The pressure relief device 100 may also have any other geometry, for example, an oval geometry, angular geometry or the like.

The pressure relief device 100 comprises a base member 102, a closure element 104 and a cover 106.

The pressure relief device 100 is in particular configured for arrangement in a relief opening 108 in a housing 110.

The housing 110 may in particular be a battery storage housing in which a plurality of battery modules which are not illustrated in the drawings can be received. A battery module may preferably comprise one or more battery cells.

The housing 110 may preferably surround an interior 112.

As a result of the relief opening 108 in the housing 110, a fluid connection may be formed between the interior 112 and an outer side 114.

The pressure relief device 100 can be arranged to close the relief opening 108 of the housing 110 in the relief opening 108 and is configured to open the relief opening 108 when a defined activation pressure is exceeded in the interior 112 of the housing 110, for example, an excess pressure or burst pressure. The medium which is in the interior 112, for example, a gas, can thereby be discharged to an outer side 114.

The base member 102 can be fixed in the relief opening 108 of the housing 110.

Preferably, there is configured on the base member 102 a bayonet closure 116 by means of which the base member 102 can be fixed in the relief opening 108 by means of corresponding engagement elements 118 which are formed on the housing 110.

Alternatively, the base member 102 on the housing 110 may be able to be fixed in the relief opening 108 by means of a plug connection, screw connection, locking connection, clip-fit connection or the like.

In another alternative embodiment, the base member 102 may be configured integrally with the housing 110 or a housing component of the housing 110.

The base member 102 has a substantially round geometry. Preferably, the geometry of the base member 102 is adapted to a geometry of the relief opening 108. The base member 102 may also have an oval, angular or any other geometry.

The base member 102 is preferably made at least partially from a suitable thermoplastic plastics material or from a composite material, for example, PBT-GF30.

The base member 102 may preferably be in the form of a shaped member, in particular a plastics material shaped member, for example, an injection-molded element.

The base member 102 may also be formed from any other suitable material, for example, a metal, in particular a light metal.

The base member 102 comprises a passage 120 which connects an inlet 122 and an outlet 124 for throughflow of the medium, in particular the gas.

The base member 102 has an outer circumferential portion 126 which forms an abutment region which faces the housing 110.

Preferably, there is provided in the outer circumferential portion 126 a recess 128 in which a sealing element 130 is arranged. As a result of the sealing element 130, a gas-tight and/or fluid-tight sealing between the base member 102 and the housing 110 is formed.

The passage 120 has a preferably round flow cross section.

The passage 120 can be closed by the closure element 104.

In FIG. 1, the closure element 104 is arranged in a closed position 132 in which a throughflow of the passage 120 with the medium is prevented.

Preferably the closure element 104 bears in the closed position 132 on a support portion 134, which delimits the passage 120, of the base member 102.

The closure element 104 has a substantially round geometry. In particular, the geometry of the closure element 104 is adapted to the geometry of the passage 120.

The closure element 104 is preferably at least partially formed by a suitable thermoplastic plastics material or from a composite material, for example, PBT-GF30.

The closure element 104 may also be formed from any other suitable material, for example, a metal, in particular light metal.

The closure element 104 may be composed of several components.

The closure element 104 or the plurality of components of the closure element 104 may be in the form of a shaped member, in particular a plastics material shaped member, for example, injection-molded shaped components.

Preferably, on the closure element 104 there is provided a sealing element 136 by means of which the closure element 104 bears in the closed position 132 in a sealing manner on the abutment portion 134 of the base member 102.

The sealing element 136 may be in the form of a ring seal and be arranged on a circumferential portion of the closure element 104.

Preferably, the sealing element 136 may be in the form of a separate component and be fitted to the closure element 104.

The sealing element 136 may also be injected onto the closure element 104, for example, the closure element 104 and the sealing element 136 may be in the form of a two-component injection-molded component.

The sealing element 136 may be formed from an elastomer plastics material.

The closure element 104 can be moved by means of a setting movement from the closed position 132 into an open position 136 illustrated in FIG. 2.

The setting movement for moving the closure element 104 from the closed position 132 into the open position 138 can be controlled by means of a setting device.

The setting device 140 is in particular configured, when the defined activation pressure is exceeded, to control the setting movement of the closure element 104 from the closed position 132 into the open position 138.

Preferably, the setting device 140 comprises a piston 142 which is coupled to the closure element 132 and an energy storage element 144 which controls the setting movement.

The piston 142 and the closure element 132 may be two separate components which are coupled to each other or are formed integrally with each other.

The energy storage element 144 may in particular be a resilient element, for example, a helical spring.

In the closed position 132 of the closure element 104, the energy storage element 144 is provided in an activated configuration, in particular the resilient element is provided in a pretensioned configuration.

When the defined activation pressure is exceeded, the energy storage element 144 is activated or actuated and controls the setting movement of the piston 142 which acts on the closure element 104 in order to move it from the closed position 132 into the open position 138.

In particular, the resilient element when the defined activation pressure is exceeded is relaxed by means of activation or actuation and acts with a resilient force on the piston 142 in order to control the setting movement and to move the closure element 104 from the closed position 132 into the open position 138.

In order to activate the energy storage element 144, the setting device 140 may preferably have a pressure activation apparatus 146.

The pressure activation apparatus 146 may be associated at the inlet side with the interior 112 of the housing 110.

Preferably, the pressure activation apparatus 146 may be configured so that an inlet-side media pressure, in particular a gas pressure in the interior 112 of the housing 110, acts on it and, when the defined activation pressure has been exceeded, the pressure activation apparatus 146 can activate or actuate the energy storage element 144 so that via the piston 142 the setting movement of the closure element 104 is controlled.

The setting movement of the closure element 104 from the closed position 136 into the open position 138 is in particular carried out relative to the base member 102 in a setting movement direction R in the direction toward the outer side 114.

The closure element 104 is configured, when the defined activation pressure is exceeded in the interior 112 of the housing 110, to release the passage 102 via the setting movement.

The cover 106 is coupled to the closure element 104 and, in order to release the passage 120, carries out together with the setting movement of the closure element 104 a setting movement from the closed position 132 into the open position 138.

In particular, the cover 106 is fitted to the closure element 104, for example, the cover 106 can be fitted to the closure element 104 by means of a plug connection, locking connection, weld connection, adhesive-bonding connection or the like.

Alternatively, the cover 106 may be formed integrally with the closure element 104 or with a component of the closure element 104.

The cover 106 may preferably be in the form of a shaped member, in particular a plastics material shaped member, for example, an injection-molded element.

The cover 106 is formed by a cover portion 148 and a circumferential portion 150 which surrounds the cover portion 148 at the circumference.

On the cover 106 there may be provided one or more retention elements 152 by means of which the cover 106 is fitted to the closure element 104.

Preferably, the cover 106 may be fitted to the closure element 104 with a spacing therefrom, for example, a gap may be formed between the cover 106 and the closure element 104.

The circumferential portion 150 of the cover 106 extends from the cover portion 148 in such a manner in a form curved in the direction toward the base member 102 that the circumferential portion 150 covers an outer circumference 154 of the closure element 104.

Preferably, there is provision for an end portion 156 of the circumferential portion 150 of the cover 106 not to extend further in the direction of the base member 102 than a lower side of the closure element 104 facing the passage 120.

In the open position 138, the cover 106 and the closure element 104 are in a raised position with respect to the base member 102, in particular with respect to an outlet-side edge region 158, which delimits the passage 120, of the base member 120.

Preferably, the passage 120 is released in the open position 138, that is to say, in the raised position of the cover 106 and the closure element 104, by means of a free circumferential flow cross section Q with respect to the outer side 114.

In particular, as a result of the free circumferential flow cross section Q in the open position 138 of the cover 106 and the closure element 104, that is to say in the raised position of the cover 106 and the closure element 104, the outlet 124 to the outer side 114 is formed.

Preferably, as a result of the free circumferential flow cross section Q in the open position 138 of the closure element 104 and the cover 106 for the medium flowing through the outlet 124 to the outer side 114, a flow path S which is free from diversions in a radial direction is formed.

This flow path S which is free from diversions in a radial direction is preferably formed by the cover 106 in the open position 138, that is to say in the raised position with respect to the base member 102, being formed by a spacing A in a setting movement direction R between the end portion 156 of the cover 106 and the base member 102, in particular the edge region 158, which delimits the passage 120, of the base member 120.

The spacing A provided in the setting movement direction R between the end portion 156 of the cover 106 and the base member 102, in particular the edge region 158, delimiting the passage 120, of the base member 120 may be 10 mm or more, preferably 20 mm or more, in a particularly preferred manner 30 mm or more.

In this manner, the cover 106, in particular the end portion 156, does not form any obstacle to flow so that the medium flowing out of the outlet 124 can be discharged in the radial direction with no diversions toward the outer side 114.

The passage 120 can thereby be released by the greatest possible flow cross section Q of the outlet 124 so that the medium can flow with a large volume flow toward the outer side 114 or for the medium a throughflow of the passage 120 with low pressure loss from the interior 112 to the outer side 114 is enabled.

A rapid discharge of the medium from the interior 112 of the housing 110 can thereby be enabled.

In the closure element 104, a gas passage 160 may preferably be provided. As a result of the gas passage 160, in the closed position 132 of the closure element 104 a gas exchange between the inlet-side interior 112 and the outlet-side outer side 114 can be ensured.

In particular, as a result of the gas passage 160 in the closed position 132 of the closure element 104 below the defined activation pressure, a pressure compensation between the interior 112 of the housing 110 and the outer side 114 may be provided.

The gas passage 160 may enable both the gas exchange from the interior 112 in the direction of the outer side 114 and in the opposite flow direction.

Through the gas passage 160, in particular the gas exchange between the interior 112 and the outer side 114 is enabled and a fluid exchange between the interior 112 and the outer side 114 is prevented.

Preferably, the gas passage 160 is formed by one or more apertures, channels, holes or the like.

Preferably, a gas-permeable and fluid-non-permeable element 162 is arranged in the gas passage 160. The gas-permeable element 162 may in particular be in the form of a permeable membrane.

In the cover 106 there may be formed one or more apertures 164 through which the medium which is discharged through the gas passage 160 can be discharged to the outer side 114.

The medium discharged through the gas passage 160 can also be discharged through the spacing or the gap which is formed between the cover 106 and the closure element 104 toward the outer side 114.

### LIST OF REFERENCE NUMERALS

100 Pressure relief device
102 Base member
104 Closure element
106 Cover
108 Relief opening
110 Housing
112 Interior
114 Outer side
116 Bayonet closure
118 Engagement elements
120 Passage
122 Inlet
124 Outlet
126 Outer circumferential portion
128 Sealing element
130 Recess
132 Closed position
134 Abutment portion
136 Sealing element
138 Open position
140 Setting device
142 Piston
144 Energy storage element
146 Pressure activation apparatus
148 Cover portion
150 Circumferential portion
152 Retention element
154 Outer circumference
156 End portion
158 Edge region
160 Gas passage
162 Gas-permeable element
164 Aperture

1. A pressure relief device for opening a relief opening in a housing or a battery storage housing, the pressure relief device comprising: a base member which is arranged in the relief opening and which has a passage which connects an inlet and an outlet for the throughflow of a medium, a closure element which, when a defined activation pressure has been exceeded, is moved from a closed position in which the closure element closes the passage into an open position in which the closure element releases the passage, and a cover which at least partially covers the closure element and/or the passage and in order to release the passage carries out a setting movement with the closure element.

2. The pressure relief device as claimed in claim 1, wherein the cover is coupled to the closure element and carries out the setting movement together with a setting movement of the closure element from the closed position into the open position.

3. The pressure relief device as claimed in claim 1, wherein the cover is fitted to the closure element, and wherein, optionally, the cover is fitted to the closure element by means of a plug connection, locking connection, weld connection, adhesive-bonding connection or a connector.

4. The pressure relief device as claimed in claim 1, wherein the cover is formed integrally with the closure element or with a component of the closure element.

5. The pressure relief device as claimed in claim 1, wherein the outlet in the open position of the closure element and the cover has a flow path free from diversions in the radial direction for the medium which flows through the outlet to an outer side.

6. The pressure relief device as claimed in claim 1, wherein the cover and the closure element in the open position are arranged in a position which is raised with respect to the base member and in which the passage through a free circumferential flow cross section of the outlet to an outer side is released.

7. The pressure relief device as claimed in claim 1, wherein the cover has a cover portion and a circumferential portion which delimits the cover portion, and wherein the circumferential portion extends in such a manner that it at least partially covers an outer circumference of the closure element.

8. The pressure relief device as claimed in claim 5, wherein in the open position the diversion-free flow path of the outlet to the outer side is formed by a spacing which is formed in a setting movement direction between an end portion of the cover and the base member or the end portion of the cover and an edge region, which delimits the passage, of the base member.

9. The pressure relief device as claimed in claim 1, wherein the closure element has a gas passage through which in the closed position of the closure element a gas exchange is provided between an inlet-side interior and an outlet-side outer side.

10. The pressure relief device as claimed in claim 9, wherein a gas-permeable and fluid-non-permeable element or a permeable membrane is provided in the gas passage.

11. The pressure relief device as claimed in claim 1, wherein there is provided a setting device by means of which, when the defined activation pressure is exceeded, the setting movement of the closure element and/or the cover from the closed position into the open position is controlled.

12. The pressure relief device as claimed in claim 11, wherein the setting device has an energy storage element which is actively connected to the closure element and/or the cover and which, when the defined activation pressure is exceeded, controls the setting movement of the closure element and/or the cover.

13. The pressure relief device as claimed in claim 1, wherein the base member and/or the closure element and/or the cover is at least partially formed from a composite material or a thermoplastic plastics material.

14. The pressure relief device as claimed in claim 1, wherein the base member is fixed in the relief opening of the housing, or the base member is fixed in the relief opening of the housing by means of a bayonet closure, a plug connection, screw connection, locking connection, clip-fit connection or a connector, or the base member is formed integrally with the housing or a component of the housing.

15. A housing or a battery storage housing, for receiving one or more battery modules, the housing or the battery storage housing comprising: a housing member which surrounds an interior, and at least one relief opening which is provided in the housing member and which forms a connection between the interior and an outer side, wherein in the at least one relief opening a pressure relief device as claimed in claim 1 is provided.
